(19) United States
(12) Patent Application Publication
(10) Pub. No.: US 2005/0284908 A1
(43) Pub. Date: Dec. 29, 2005

(54) Unit for securely storing equipment

(76) Inventors: William M. Greenwood, Wausau, WI (US); B. Todd Hancock, Schofield, WI (US); Troy M. Rebeck, Wausau, WI (US)

Correspondence Address: DILWORTH & BARRESE, LLP, 333 EARLE OVINGTON BLVD., UNIONDALE, NY, 11553, US

(21) Appl. No.: 10/880,314

(22) Filed: Jun. 29, 2004

(51) Int. Cl. B60R 11/00

(52) U.S. Cl. 224/547

(57) ABSTRACT

A box for securely storing equipment on board a vehicle includes detachably coupling base and cover, which are configured to slide relative to one another to a secured position, in which the equipment is enclosed. The base and cover are configured to press against one another with a gradually increasing force during their displacement towards the secured position, while pressing against each other to prevent involuntary displacement of the cover from the secure position.

### BACKGROUND OF THE INVENTION

1. Field of the Invention

The present invention relates to a unit for securely storing equipment used on board a vehicle. Particularly, the invention relates to a box for securely storing variously dimensioned equipment, used on board the vehicle, and for minimizing vibrational loads acting upon the stored equipment during the operation of the vehicle, as well as, avoiding impact damage to the equipment resulting from the vibrational loosening of fasteners securing the equipment.

2. Discussion of the Related Prior Art

Storing and transporting equipment on board vehicles, such as a watercraft, automobiles, trains, aircraft and others, typically encounters problems. For example, with the advent of electronic technology, the operation of vehicles utilizes more and more stationary, as well as, portable sophisticated electronic devices to assist the operator in a variety of ways, such devices including, for example, navigation (GPS) units, fish locators, etc. Typically, sophisticated electronic equipment, such as the aforesaid, are relatively expensive. Leaving such equipment in the vehicle in the absence of its operator may attract thieves and vandals to steal or destroy the equipment. Accordingly, the owner of the vehicle may incur additional and unnecessary expenses, to replace the equipment as well as inconveniences associated with at least temporarily operating the vehicle in the absence of the stolen or destroyed equipment. To avoid these problems, various types of protective closeable storage devices have been employed.

Furthermore, regardless of the type of the vehicle being operated, the vehicle typically experiences significant vibrational loads tending to loosen the equipment from their mountings and/or loosen the protective closable storage devices for the equipment creating annoying vibrational noises and rattling. As a consequence, the storage device may inadvertently open, the equipment may fall from their mountings, and the stored equipment may start experiencing even greater vibrational loads and detrimental damaging affects. Particularly affected by the vibrational loads may be storage devices and stored equipment used on board watercraft and automobiles which travel along rough water and terrain.

Some of the above-discussed problems have been addressed by devices, such as boxes, configured to prevent theft of various items and to minimize vibrational loads on these items. For example, U.S. Pat. No. 5,520,313 discloses a lockable storage device mounted on a vehicle and having a cover, which rotates relative to a base between open and closed positions. Configured to accommodate cups and bottles, the storage device has a complicated structure of multiple springs minimizing the negative effect of vibrational loads on the stored articles.

U.S. Pat. No. 6,035,800 discloses a floatable storage box removably attachable to a gunwale of a canoe or similar small watercraft and configured to store various valuables. The structure of the disclosed storage box includes a base, a lid hinged to the base and pivotal between closed and open positions, and a latching device operative to lock the box in the closed position of the lid. The disclosed box lacks a means for damping vibrational loads.

It is, therefore, desirable to provide a storage unit configured to securely store equipment used on board of a vehicle and to effectively withstand the vibrational loads originated on board the vehicle.

### SUMMARY OF THE INVENTION

Thus, an object of the invention is to provide a unit for securely storing equipment used on board a vehicle thereby preventing damage to the equipment and unauthorized access to the stored equipment.

A further object of the invention is to provide a storage box having a structure capable of reliably maintaining the box in a secured or closed position while the box is experiencing vibrational loads.

Still a further object of the invention is to provide a storage box with a structure configured to reliably mount variously dimensioned and shaped equipment within the box.

Still other object of the invention is to provide a storage box with a simple and cost-efficient structure.

Another object of the invention is to provide a method for securely storing equipment on board a vehicle.

These and other objects have been achieved by the inventive storage box shaped and dimensioned to reliably enclose and securely store various equipment typically used on board a vehicle. The inventive box is configured with a base and cover detachably attached to one another and slidable relative to one another to a secured position, in which the equipment, removably coupled to either the base or cover, is securely stored.

In accordance with one aspect of the invention, the box is provided with an engaging assembly configured so that the base and cover slide relative to each other to the secured position while experiencing a gradually increasing friction between their engaging portions. Having reached the secured position, the base and cover tend to tightly press against one another. As a consequence, incidental opening of the box in the secured position and rattling due to vibrational loads are minimized or eliminated. Furthermore, since the closed box damps at least a portion of the vibrational loads, the risk of damage to the stored equipment is also reduced.

A further aspect of the invention relates to a mounting bracket configured to be removably attached to either the base or cover of the inventive box and having a pair of spaced uprights which flank the equipment to be stored. Two locking elements each are mounted on the free end of the respective upright so that these elements are operative to move relative to one another at a selective distance to engage the equipment from the opposite sides. Accordingly, equipment of various outer dimensions and shapes can be reliably mounted and stored within the box.

In accordance with still a further aspect of the invention, the box is provided with a locking assembly configured to lock the box after the base and cover have reached the secured position. As a result, equipment is securely stored inside the box and can be left unattended on board. Also, the locking assembly is not only operative to lock the box, but it is also operative to move the base and cover relative to one another from a loose position, in which these components of the box can be coupled together, to the secured position.

### BRIEF DESCRIPTION OF THE DRAWINGS

The above and other features, objects and advantages will become more readily apparent from the following detailed description of the invention illustrated by the accompanying drawings, in which:

FIG. 1 is a perspective view of a box configured in accordance with the invention and shown in a secured position;

FIG. 2 is an exploded perspective view of the box of FIG. 1;

FIG. 3 is a top plan view of a base of the box of FIG. 1;

FIG. 4 is an elevational front view of the base of FIG. 2;

FIG. 4A is a sectional view of an alternative embodiment of the engaging assembly configured to ensure the secured position of the box of FIG. 1;

FIG. 5 is a rear perspective view of a lid of the box attachable to the frame of the cover of FIG. 2; and

FIG. 6 is sectional view of a bracket for mounting equipment to be stored within the box of FIG. 1.

### DETAILED DESCRIPTION OF THE INVENTION

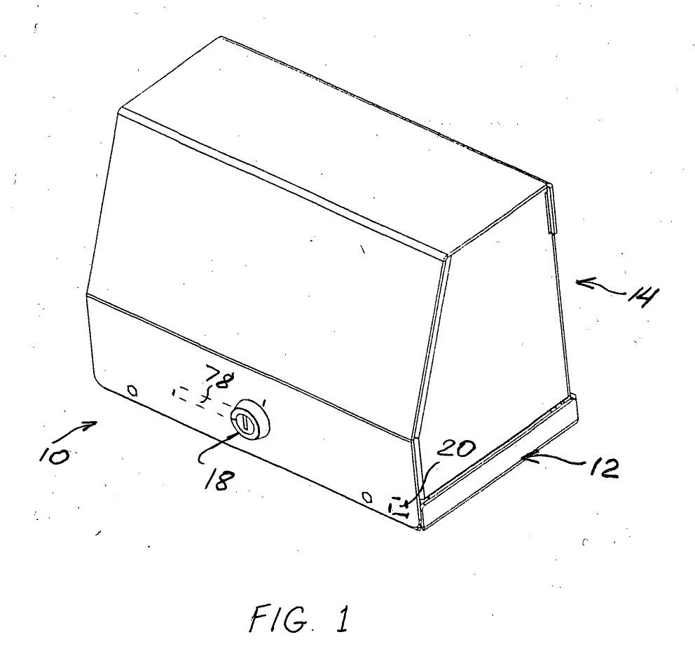

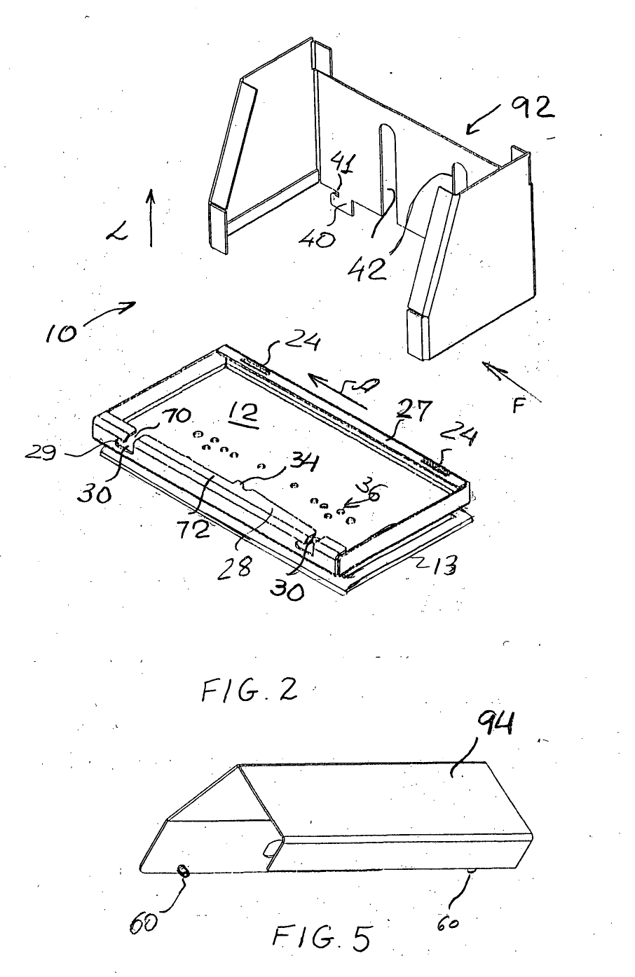

Referring to FIGS. 1-2, a box 10 is configured to securely store various equipment including, but not limited to, portable electronic devices such as fish locators and GPSs (global positioning systems). Configured with a base 12 and cover 14 removably attachable to one another, the box 10 preferably includes a locking assembly 18 operative to lock the box 10 so that the base 12 and cover 14 cannot be detached from one another unless the locking assembly 18 is activated. As a consequence, the locked box 10 prevents easy access to the stored equipment by unauthorized individuals. To further ensure safety of the stored equipment, the box 10 may include a sensor 20 positioned, for example, between the base 12 and cover 14 and coupled to the locking assembly 18 so that if the box 10 is attempted to be broken in without using the key, the sensor 20 can generate an alarm signal. The sensor 20 may be a photo sensor, which can be deactivated upon insertion of the key into the keyhole of the locking assembly 18. Unless the key is used, any other alternative opening of the box 10 will set off the sensor 20 actuating a sound or visual alarm system which may be mounted anywhere to the box 10. Alternatively, the sensor 20 may generate a signal transmitted to a portable receiver carried by the operator and capable of alarming the operator of the unauthorized attempt to open box 10.

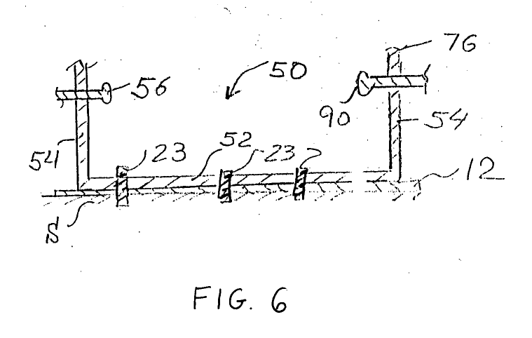

One of the base 12 or cover 14 may be provided with a means for removably mounting the box 10 to a supporting surface by utilizing various known fastening elements. For example, the bottom of the base 12 can have multiple suction cups attachable to the support surface, or can receive screws 23 or bolts (FIG. 6) coupling the base to the supporting surface S. Instead of the base 12, the cover 14 can be provided with the disclosed fastening elements for suspending the cover 14 to the underside of a supporting surface. Optionally, a gasket 13 may be interposed between the base 12 and the supporting surface to which the base 12 is secured. Gasket 13 is preferably fabricated from a resilient material, such as rubber, or electromeric synthetic polymer to help dampen vibrations. After attaching the cover 14 to the supporting surface, the equipment can be enclosed by the base 12 attachable to the cover 14. The cover 14 can be formed of a unitary construction, or, as shown in FIGS. 2 and 5, can be assembled of individual components including a frame 92 and a lid 94. In addition, the box 10 can have a handle to allow the operator to easily transport the box 10 with or without the stored equipment.

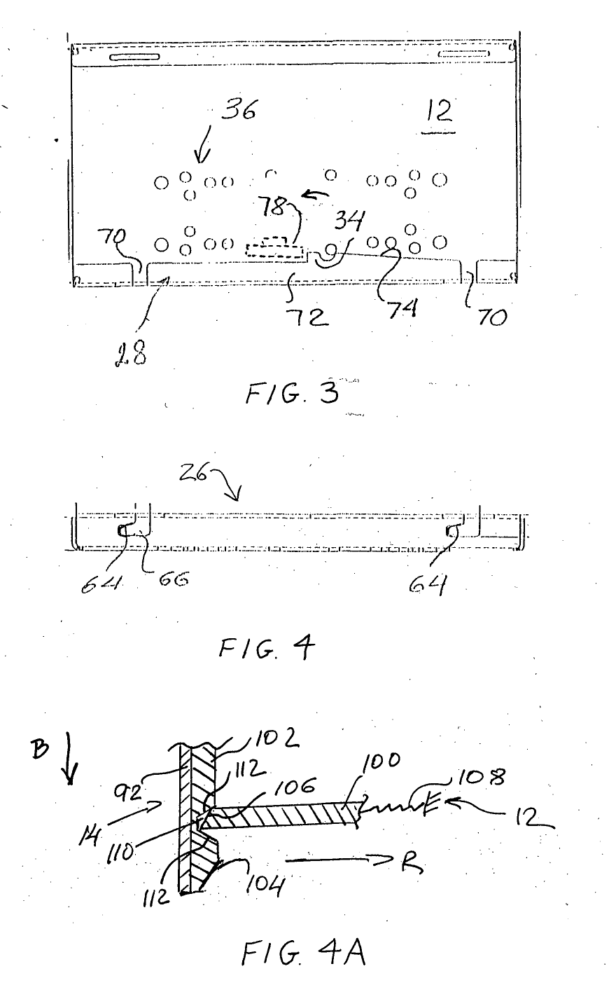

In the preferred embodiment, both the base 12 and cover 14 have a polygonal shape, as shown in FIGS. 1-3, although they may have any other shape. Regardless of the shape, the base 12 and cover 14 are configured so that upon initial attachment in a loose position, these components can slide relative to one another to a secured position (FIG. 1), in which their involuntary decoupling is minimized. To establish the secured position, initially the cover 14 is juxtaposed with the base 12 so that at least one, but preferably several lugs 40 (FIG. 2) and projections 60 (FIG. 5) are inserted into openings 24 and recesses 30 (FIGS. 2, and 3) of the base 12, respectively. The openings 24 and recesses 30 are shaped and dimensioned to guide the lugs 40 and projections 60 in a direction of arrow A (FIG. 2) in response to an external force F. Initial insertion of the lugs 40 and projections 60 defines the loose position of the cover 14 and base 12, in which these components can be separated by lifting the cover 14 in a direction of arrow L (FIG. 2) transversely to the direction of arrow A. Upon applying the external force F, the cover 14 and base 12 slide relative to one another to the secured position, in which hook portions 41 (FIG. 2) of the lugs 40 engage the underside of rear side 27 (FIG. 2) of the base 12 provided with the openings 24, while the projections 60 are received in an end portion 29 of the recesses 30.

Any operating vehicle, particularly a watercraft, is associated with various vibrational loads, which can detrimentally affect engagement between the base 12 and cover 14 even in the secured position. According to the present invention, when the base and cover are in the secured position, the box 10 diminishes the effect of these loads on the stored equipment. However, in prior art boxes, positioning the cover 14 and base 12 in the secured position ensures only that the cover 14 cannot be lifted off the base 12. Unless these components are reliably engaged in the secured position, the vibrational effects of the vehicle cause unwanted rattling and may cause the cover to gradually slide back to the loose position and incidentally detach from the base 12. To avoid such gradual displacement of the cover 14 from the secured position, the box 10 of the present invention has an engaging assembly configured to at least minimize the effect of these loads on the engaged base and cover.

The engaging assembly includes the projections 60 (FIG. 5) extending from the inner surface of the lid 94 transversely to longitudinal guide surfaces 64, 66 of the recesses 30 (FIG. 4), which are provided on a front side 26 of the base 12. Engagement between the edges 64, 66 of the guide surfaces and the projections 60 generates a gradually increasing frictional force between the base 12 and cover 14, as these elements move towards the secured position. Preferably, the top edge 64 the longitudinal guide surfaces is inclined relative to bottom edge 66 of the longitudinal guide surface so that opposing edges 64, 66 (FIG. 4) of the recess 30 converge towards one another and towards the end of the recess 30. As a consequence, as the cover 14 is slid in the direction of arrow A (FIG. 2) the projections 60 move along top edge 64 of recesses 30, so that the cover 14 is urged towards base 12. The friction between the recesses and the projections 60 gradually increases during displacement of the base 12 and cover 14 towards the secured position. The shape and dimensions of the projection 60 and recess 30 are such that displacement of the base 12 and cover 14 from the secured position is minimized, even if the box 10 experiences great vibrational loads. Preferably, the projections 60 are configured as pins with a uniform diameter, and alternatively, may have a polygonal cross-section.

The front side 26 of the base 12 has a flange 28 (FIGS. 2, 3) extending towards the rear side 27 of the base and provided with gaps 70, which are formed adjacent to the recesses 30 and configured to guide the projections 60 into these recesses to establish the loose position of the cover 14 and base 12. A central portion 72 (FIG. 3) of the flange 28 has a tab 34 extending from an inner edge 74 of the flange 28 and cooperating with a lever 78 (FIGS. 1, 3) of the locking assembly 18 so as to displace the cover 14 and base 12 to the secured position. As shown in phantom in FIG. 3, the lever 78 is coupled to the locking assembly 18 so that when the key of the locking assembly rotates when the cover is in the loose position, the lever 78 comes in contact with the tab 34 before the key completes the desired rotation. As a result, continuing the rotation of the key causes the lever 78 to press against the support 34 thereby generating a linear force, which helps displace the cover 14 relative to the base 12 to the secured position. Once the latter is reached, the rotation of the key is complete, and the box 10 cannot be open without using the key again. Note that although the locking assembly 18 and projections 60 (FIG. 5) are shown mounted to the lid 94 of the cover 14 (FIG. 1), repositioning these elements so that they would be provided on the base 12, while the recesses 30 on the lid 94, is a matter of simple structural rearrangement.

The locking assembly is required to lock the box for storing purposes. However, if the operator does not need to lock the box 10, but simply needs to close it with or without the equipment, displacement of the base 12 and cover 14 between the loose and secured positions may be realized manually.

In an alternative embodiment of the engaging assembly, the cover 14 may be placed on top of the base 12, and either under gravity or in response to a vertical force may be engaged the secured position, in which it is automatically locked. As diagrammatically shown in FIG. 4A, the box 10 can be provided with at least one spring-loaded shaft 100 suspended on the base 12 and a pin 102 fixed to the frame 92 of the cover 14. As the cover 14 is lowered toward the base 12 in the direction of arrow B, a slanted bottom surface 104 of the pin 102 presses against a surface 106 of the shaft 100, which is slanted complementary to the surface 104. Overcoming a spring force generated by a spring 108 displaces the shaft 100 in a direction of arrow R. To lock the base 12 relative to the cover 14, the pin 102 is provided with an opening 110 dimensioned to receive surface 106 of the shaft 100 when the opening 110 becomes aligned with the shaft, which thus moves into the opening 110 by the spring force. Unlocking and opening the cover 14 can be realized by a key configured to displace the shaft 100 in the direction of arrow R upon overcoming the spring force. Numerous modifications of the key can be readily utilized within the scope of this invention provided that such a key can actuate one of the engaged pin and shaft.

To prevent undesirable vibration of the base 12 and cover 14 in the secured position, guiding surfaces 112, defining the opening 110 of the pin 102, converge towards one another so as to increase friction between the shaft 100 and pin 102. As a consequence, the base 12 and cover 14 are tightened against each other in the secured position.

As shown in FIGS. 2 and 3, the base 12 has a plurality of openings 36 arranged to removably receive a bracket 50 (FIG. 6) for mounting equipment to the base. The bracket 50 is configured with a plate 52 attachable to the base 12 and uprights 54, which are spaced apart at a distance sufficient to receive variously dimensioned equipment therebetween. To prevent displacement of the equipment relative to the base 12, the uprights 54 each have a respective free end 76 traversed by a locking element 56, which can be a screw, pin and the like. Moving the locking elements to reliably engage the equipment therebetween completes the mounting operation. Inner ends 90 of the locking elements 56 may have a greater diameter than the rest of these elements to increase a contact area with the equipment. While the bracket 50 is disclosed as attached to the base 12, it can be mounted to the cover 14.

Referring to FIG. 2 and 4, the cover 14 is configured with a frame 92 and lid 94 attachable to the frame. A buoyant material, such as styrofoam, or a closed cell foam can be affixed to the cover 14 to render it floatable. Alternatively, the cover 14 or the entire box 10 can be fabricated to provide enclosed void spaces to render the cover 14 and box 10 buoyant. The rear side of the frame 92 has one or more slots 42 each configured to receive cable and wires coupling the stored equipment to outside devices, such as an outside power source. Slots 42 can be dimensioned and spaced in any suitable manner so as to accommodate various sizes of wires and cables. Each of the individual components of the box 10 may be die cast from suitable metals or molded from engineering plastics, for example, polyacetals, polycarbonates, polyamides, etc. It is contemplated that the mentioned engineering plastics may incorporate metal stiffeners in order to provide sufficient rigidity. Further, the components of the box 10 can be manufactured by filling a metal frame with polymeric engineering plastic, such as any of those mentioned above, to provide a lightweight but sturdy, reinforced box 10.

Although the preferred embodiments of the present invention have been disclosed for illustrative purposes, those skilled in the art will appreciate that various modifications, additions, materials and substitutions are possible, without departing from the scope and spirit of the invention as disclosed in the accompanying claims.

1. A box for securely storing equipment on board a vehicle, comprising a base and a cover, one of the base and cover being removably mountable to a support surface of the vehicle and detachably couplable to equipment, the base and the cover being detachably coupled to and slidable relative to one another to a secured position so that the base and cover are gradually compressed against one another from a loose position to the secured position, to secure equipment herein.

2. The box of claim 1, wherein friction between the base and cover increases as the cover moves from the loose position to the secured position.

3. The box of claim 2, further comprising an engaging assembly located between the base and cover and configured to press the base and the cover, relative to one another in the secured position so as to prevent loosening of the cover relative to the base in response to vibrational loads acting upon the box.

4. The box of claim 3, wherein the engaging assembly includes at least one projection formed on the one of the base and cover and a 1 recess formed on the other one of the base and cover and extending transversely to the at least one projection, whereby a friction between the at least one projection and recess gradually increases as the base and cover move from the loose position to the secured position.

5. The box of claim 4, wherein at least one of the projection and recess has a pair of opposing guide surfaces extending non-parallel to one another and urging against respective juxtaposed surfaces of the other to gradually increase the friction between the base and cover as the base and cover move towards the secured position.

6. The box of claim 4, wherein the at least one projection is provided on the cover and the recess is formed on the base and conversely.

7. The box of claim 2, wherein the base and cover each has a peripheral surface opposing to a peripheral surface of the other in the loose position, the peripheral surface of the one of the base and cover being provided with spaced openings to receive a respective lug formed on the peripheral surface of the other of the base and cover.

8. The box of claim 7, wherein the spaced openings each are shaped and dimensioned to slidably guide the lugs to the secured potion of the base and cover.

9. The box of claim 8, wherein the lug includes a hook portion engaging an underside of the peripheral surface formed with the spaced openings to prevent separation of the base from the cover in the secure position.

10. The box of claim 1, further comprising a mounting assembly removably attachable to a surface of the one of the base and cover and configured to receive the equipment so that the equipment and the supporting surface are fixed relative to one another.

11. The box of claim 3, further comprising a locking assembly mounted on the one of the base and cover and operative to lock the box in the secured position, thereby preventing detachment of the base from the cover.

12. The box of claim 11, wherein the locking assembly includes a latch operative to rotate about an axis while pressing against a stationary support mounted on the other one of the base and cover with a force sufficient to displace the base and cover relative to one another from the loose position to the secured position.

13. The box of claim 1, wherein the one of the base and cover has at least one slot configured to provide an access for an electrical line between the equipment stored in the box and an outside equipment, the equipment stored in the box including portable electronic devices.

14. The box of claim 11, further comprising at least one sensor coupled to the locking assembly and operative to generate an alarm signal upon an attempt of opening the box in the secured position without actuating the locking assembly.

15. The box of claim 3, wherein the engaging assembly includes a spring-loaded shaft mounted to the base and a pin fixed to the cover and configured to displace the shaft as the cover is lowered towards the secured position relative to the base, the pin being provided with an opening dimensioned to lockingly receive the shaft upon reaching the secured position.

16. The box of claim 15, wherein the pin has a slanted bottom surface extending complementary to an end surface of the shaft so that the slanted bottom surface slidably engages the end surface of the shaft and displaces the shaft against a force of a spring as the cover moves towards the secured position, the opening being aligned with the end surface of the shaft in the secured position and dimensioned to be traversed by the shaft.

17. The box of claim 15, wherein the opening has guide surfaces converging towards one another to engage the shaft with a gradually increasing frictional force as the shaft slides into the opening in the secured position, whereby the cover and base are pressed against one another in the secured position.

18. The box of claim 10 further comprising a gasket interposable between the supporting surface and one of the base and cover.

19. A box for securely storing equipment comprising:
a base having a peripheral surface; and
a cover removably attachable to the base and having a peripheral surface facing the peripheral surface of the base during attachment of the cover to the base, one of the peripheral surfaces of the base and cover being provided with at least one recess, and the peripheral surface of the other having at least one projection extending transversely to the recess, the projection slidably engaging the recess so that as the base and cover slide relative to one another to a secured position in response to an external force applied thereto, friction between the projection and recess gradually increases to tighten the base relative to the cover in the secured position.

20. The box of claim 19, wherein the recess has a hooked end portion provided with spaced edges for receiving the projection therebetween and converging towards one another to gradually increase friction between the recess and projection as the cover and base slide to the secured position.

21. A method of securely storing equipment in a unit, comprising the steps of:
removably attaching equipment to one of a base and cover;
removably coupling the base to the cover;
applying an external force to the one of the base and cover, thereby linearly displacing the base and cover relative to one another to a secured position, wherein the base and cover are configured to press against each other with a gradually increasing force as the base and cover approach the secured position.
